(19) United States
(12) Patent Application Publication
(10) Pub. No.: US 2017/0338482 A1
(43) Pub. Date: Nov. 23, 2017

(54) MATERIAL OF NEGATIVE ELECTRODE FOR LITHIUM SECONDARY BATTERY

(71) Applicant: KOREA UNIVERSITY RESEARCH AND BUSINESS FOUNDATION, Seongbuk-gu (KR)

(72) Inventors: Woo Young YOON, Seocho-gu (KR); Ye Chun JO, Uijeongbu-si (KR)

(21) Appl. No.: 15/585,069

(22) Filed: May 2, 2017

(30) Foreign Application Priority Data
May 20, 2016 (KR) 10-2016-0062320

(51) Int. Cl. H01M 4/38; C22C 30/00; H01M 4/62; H01M 10/0525; H01M 4/02

(52) U.S. Cl. CPC H01M 4/386; H01M 4/625; H01M 10/0525; C22C 30/00; H01M 4/623; H01M 2004/027

(57) ABSTRACT

The present invention is related to a material of negative electrode for a lithium secondary battery manufactured by alloying a material which does not form silicon and intermetallic compounds with silicon through the arc melting alloying. More particularly, the present disclosure is related to a material of negative electrode for lithium secondary battery wherein the capacity and life expectancy have been improved by mixing silicon and five or more kinds of metals which do not form an intermetallic compound with silicon to have almost the same atomic ratio in order to improve the volume expansion problem and initial efficiency characteristics of silicon when using silicon as the anode active material of a lithium secondary battery and by applying a buffering action to the volume expansion of the silicon in the charging and discharging process of the electrode through the use of high entropy alloy manufactured by alloying through arc melting.

### CROSS-REFERENCE TO RELATED APPLICATIONS

This application claims the benefit under 35 USC 119(a) of Korean Patent Application No. 10-2016-0062320 filed on May 20, 2016 in the Korean Intellectual Property Office, the entire disclosure of which is incorporated herein by reference for all purposes.

### BACKGROUND

### 1. Field

The present disclosure is related to a material of negative electrode for lithium secondary battery manufactured by alloying a material which does not form silicon and intermetallic compounds with silicon through the arc melting alloying. More particularly, the present disclosure is related to a material of negative electrode for lithium secondary battery wherein the capacity and life expectancy have been improved by mixing silicon and five or more kinds of metals which do not form an intermetallic compound with silicon to have almost the same atomic ratio in order to improve the volume expansion problem and initial efficiency characteristics of silicon when using silicon as the anode active material of a lithium secondary battery and by applying a buffering action to the volume expansion of the silicon in the charging and discharging process of the electrode through the use of high entropy alloy manufactured by alloying through arc melting.

### 2. Description of Related Art

Interests in energy storage technology have been growing recently. As the application fields are expanding to cell phones, camcorders, laptop PCs and even to electric vehicles, efforts for research and development of electrochemical devices are becoming more concrete. The electrochemical devices are one of the most attracting fields in this respect, and among these, the development of a rechargeable lithium secondary battery has become a focus of attention. In recent years, research and development on the design of new electrodes and batteries have been underway in order to improve operating characteristics such as energy density, reversible capacity, and initial charging efficiency in developing such batteries.

Among the currently applied secondary batteries, the lithium secondary battery developed in the early 1990s has advantages such as higher operating voltage and higher enercy density than conventional batteries such as N-MH, Ni—Cd, and sulfuric acid-lead batteries using an aqueous electrolyte solution.

Generally, a lithium secondary battery uses a material capable of intercalation/deintercalation or alloying/dealloying of lithium ions as a cathode and an anode, is manufactured by charging an organic electrolytic solution or a polymer electrolytic solution between the cathode and the anode, and generates electrical energy through oxidation reaction and reduction reaction when lithium ions are inserted and removed from the positive electrode and the negative electrode.

At present, a carbon-based material is mainly used as an electrode active material constituting a cathode of a lithium secondary battery. In the case of graphite, the theoretical capacity of it is about 372 mAh/g, and the actual capacity of graphite commercialized at present is about 350 to 360 mAh/g. However, such a carbon-based material such as graphite is not compatible with a lithium secondary battery which requires a high-capacity negative electrode active material.

To satisfy such requirement, there are examples to use silicone (Si), tin (Sn), and etc., which exhibit a higher charge and discharge capacity than a carbon-based material and which can be electrochemically alloyed with lithium, an oxide of them or an alloy with them as a negative electrode active material.

The silicon electrode is an alternative material that can solve the above-mentioned problem of the carbon material anode material. As silicon has a very high charge capacity per unit mass (4200 mAh/g), the charge capacity of existing anode materials is more than 10 times higher.

However, these materials cause a change in the crystal structure when lithium is absorbed and stored, causing a problem of the volume expansion. The characteristics of the silicon anode material are the alloying reaction in which the lithium ion reacts with the anode silicon during the charging process to produce a new compound, and dealloying reaction occurs during the discharging process. This is different from the intercalation reaction of lithium ions between a carbon-based cathode material and an interlayer structure.

In the case of silicon, when the maximum amount of lithium is absorbed and stored, it is converted into Li4.4Si, and a volume expansion due to charging is achieved. In this case, the volumetric growth rate due to charging expands to about 4. 12 times the volume of silicon before the volume expansion. Accordingly, a strong mechanical force is exerted at the time of volume expansion and the material is destroyed. This phenomenon lowers the stability and capacity of the lithium ion battery. Meanwhile, the volume expansion rate of graphite, which is currently used as a negative electrode material, is about 1.2 times.

Therefore, although a lot of studies have been conducted to reduce the volume expansion rate through alloying of silicone or the like for the purpose of increasing the capacity of the negative electrode active material such as silicon, there was a problem in practical use. The main reason for this is that the metal such as Si, Sn, and AI is alloyed with lithium during charging and discharging to cause volume expansion and contraction, which causes metal undifferentiation and deteriorates cycle characteristics. Therefore, the present invention is directed to preventing the breakdown phenomenon of the electrode due to the volume expansion occurring when using the silicon anode active material, the capacity decrease, and the cycle lifespan degradation.

### SUMMARY

The present invention is directed to improving the life expectancy of a lithium secondary battery by forming a High Entropy Alloy manufactured by mixing silicon (Si) and at least five kinds of metal elements which do not form Intermetallic Compound with silicon (Si) so as to have almost the same atomic ratio (Near-Equiatomic) and alloying through the arc melting alloying and thus preventing the destruction of anode material by achieving the buffering effect of the volume expansion of silicon (Si) in the charging and discharging process.

The present invention is directed to maintaining a better charge and discharge capacity compared to existing carbon-based anode active materials by using a High Entropy Alloy including silicon (Si) as an anode active material.

A material of negative electrode for a lithium secondary battery according to an exemplary embodiment of the present invention may comprise an anode active material containing silicon and an alloy of at least five kinds of metal elements that do not form an intermetallic compound with silicon.

Further, as metal elements which do not form the intermetallic compound with silicon, cobalt, chromium, iron, nickel, and aluminum may be used.

Further, the alloy is composed of five kinds of metal elements which do not form an intermetallic compound with silicon and silicon, and each constituent element can be formed in a composition ratio of 1:1:1:1:1:1.

Further, the alloy is a High Entropy Alloy structure that forms a solid solution.

Further, the alloy may further include at least one metal selected from the group consisting of copper, zirconium, titanium, vanadium and manganese.

Further, the alloy may further include at least one metal selected from the group consisting of tungsten, niobium, and molybdenum.

Further, the alloy has a solid solution having a certain crystal structure including a face-centered cubic lattice or a body-centered cubic lattice structure.

Further, the material of negative electrode for a lithium secondary battery may have a first discharge capacity of 1700-4200 mAh/g.

Further, the material of negative electrode for a lithium secondary battery may have a capacity retention rate of 80% to 100% from 5 cycles to 600 cycles in charging and discharging processes.

Further, the material of negative electrode for a lithium secondary battery may have a capacity retention rate of 85% to 90% from 5 cycles to 600 cycles in charging and discharging processes.

Further, the material of negative electrode for a lithium secondary battery can maintain a capacity of 1000-4200 mAh/g after 600 cycles in the processes of charging and discharging.

Further, the material of negative electrode for a lithium secondary battery may comprise a conductive material selected from the group consisting of carbon black, carbon nanotube, carbon powder, and graphite powder.

Further, the material of negative electrode for a lithium secondary battery may further comprise a binder for mixing the negative active material and the conductive material to form a slurry.

Further, the binder may comprise polyvinylidene fluoride.

Further, the slurry may be mixed with the negative electrode active material, the conductive material, and the binder in a ratio of 8:1:1.

The present invention relates to a method for forming a High Entropy Alloy alloyed with an arc melting method by mixing at least five kinds of metal elements that do not form an intermetallic compound with silicon (Si) and silicon (Si) so as to have almost the same atomic ratio, achieves a buffering effect on the volume expansion of silicon (Si) during the process of charging and discharging, and has an effect of preventing the destruction of the negative electrode material and improving the lifetime of the lithium secondary battery.

The present invention uses a High Entropy Alloy containing silicon (Si) as an anode active material, and has an effect of maintaining an excellent charging and discharging capacity as compared with a conventional carbon-based anode active material.

### BRIEF DESCRIPTION OF THE DRAWINGS

FIG. 1 is a graph showing a change in capacitance due to charging and discharging cycles of a negative electrode according to an exemplary embodiment of the present invention.

FIG. 2A is a graph illustrating an analysis result of X-Ray Diffraction: XRD of an alloy having the same composition as the High Entropy Alloy according to an exemplary embodiment of the present invention.

FIG. 2B is a graph illustrating an analysis result of X-Ray Diffraction: XRD of the High Entropy Alloy according to an exemplary embodiment of the present invention.

FIG. 3A is a photograph of TEM of the High Entropy Alloy according to an exemplary embodiment of the present invention.

FIG. 3B is a graph illustrating an analysis result of SAED of the High Entropy Alloy according to an exemplary embodiment of the present invention.

### DETAILED DESCRIPTION

The terminology used herein is for the purpose of describing particular embodiments only and is not intended to be limiting of the invention. Also, the terminology used herein is interpreted in a general sense as understood by those skilled in the art unless it is defined in different senses in the present disclosure. The terminology used herein is not intended to be interpreted in an excessively comprehensive sense or in excessively reduced meaning. Also, when the terminology is not appropriate to convey the concept of the disclosure, the terminology may be substituted by the terminology suited for those skilled in the relevant field of technology. Also, the general terminology used herein is intended to be interpreted according to the dictionary definition or according to the context in which the terminology is used, and is not intended to be interpreted in an excessively limited sense.

Also, the singular forms of expression used herein include the plural forms of expression unless they are plain different in the context. In the description of the embodiments, the terms such as “be composed of” and “include” are not used to be always interpreted as comprising all the various elements or various stages reported in the disclosure. Such terms are intended to be interpreted with a possibility in mind that some of the elements or stages are not included or that there might be additional elements or stages.

Also, in describing the present disclosure, when a concrete explanation on related technology might render the gist of the present invention unclear, the concrete explanation is omitted. Also, the accompanying drawings are not intended to restrict the idea of this disclosure but to help understanding of it.

Hereinafter, the present invention will be described more fully.

In case of the silicon alloy materials disclosed by the existing patent specifications, the alloy itself has problems. The problem is that the crystals of the alloy materials have high fragility. If the rate of crystal cracking becomes high, cracks are rapidly generated inside the negative electrode active material at a certain moment in the course of repeating the process of inserting and removing lithium, resulting in a rapid deterioration of the life expectancy characteristic of the battery.

The alloy with silicon can be divided into a solid solution alloy and an intermetallic compound depending on the type of the metal element to be processed together, and the crystal of the solid solution alloy has a relatively small degree of cracking, while an alloy with an intermetallic compound is relatively high.

Therefore, the present invention relates to a method of manufacturing a silicon-based negative electrode material by using a silicon-based negative electrode material as a negative electrode material for a secondary battery by manufacturing a High Entropy Alloy material which is alloyed with silicon and five kinds of metals to form a solid solution without forming an intermetallic compound, and the present invention is directed to solving the problem of the volume expansion in the discharging process.

More specifically, the High Entropy Alloy has a unique characteristic of forming a single phase even though the alloying elements of 4, 5 or more are mixed at a similar ratio unlike the existing alloy in which 60-99% of the main alloy is added with a small amount of other elements. This characteristic is found only in alloy systems with configuration entropy due to mixing.

The High Entropy Alloy is a multi-element alloy system with more than 5 elements in which the constituent elements are mixed at near-equiatomic rate. In general, the alloys of multiple elements in which solvent and solute are distinguished form intermetallic compounds and have very low configuration entropy. Namely, intermetallic compounds are formed by exceeding the solubility limit of the solid solution.

However, even though it is a multi-element alloy, configuration entropy due to the mixing of various elements is increased, and the total free energy is decreased without forming a compound by reduction of free energy due to intermetallic compound formation. Therefore, it is an alloy that forms a solid-solution mixed with various elements without forming the intermetallic compound between the multi-component elements or the second phase.

Namely, High Entropy Alloy is an alloying system containing at least five metal components with atomic concentrations between 5 and 35% and all added elements serving as the main element. In this system, a high mixed entropy is induced in the alloy due to a similar atomic ratio, and a solid solution having a crystal structure of a face-centered cubic lattice or a body-centered cubic lattice having excellent ductility instead of an intermetallic compound or an intermediate compound is formed.

It is known that the High Entropy Alloy solid solution exhibits intricate internal stress due to the difference in the radius of the constituent elements, thereby causing lattice strain and strengthening. Also, as at least five alloying elements act as solute atoms, they have a very slow diffusion rate and thereby mechanical properties at high temperatures are maintained.

Hereinafter, the present invention will be further explained with an exemplary embodiment. However, the scope of the present invention should not be limited by the exemplary embodiment.

### Exemplary Embodiment

In a material of negative electrode for a lithium secondary battery according to an exemplary embodiment of the present invention, a High Entropy Alloy containing silicon (Si) is used as an active material. Further, in order to increase conductivity, a carbon-based conductive material is bonded to it, and the binder is mixed to form an electrode mixture slurry so that the electrode assembly can be combined with the collector.

As the anode active material, a High Entropy Alloy containing silicon (Si) having a charge capacity per unit mass of 10 times or more higher than that of a conventional carbon-based anode active material (charge capacity per unit mass—372 mAh/g) may be used. Also, cobalt (Co), chrome (Cr), Iron (Fe), Nickel (Ni), and Aluminum (Al) are used as the metal elements constituting the alloy so as not to form an intermetallic compound with silicon (Si) and silicon (Si).

The High Entropy Alloy is not mixed with a small amount of other elements added with a large amount of silicon (Si) as a main element but is mixed with each other so that each constituent element including silicon (Si) has almost the same atomic ratio (Near-equiatomic). And there was no principal element, and all the added elements acted as main elements.

Specifically, 5 to 35 atomic percent (atomic percent-hereinafter at %) of silicon (Si) and also 5 to 35 at % of cobalt (Co), chromium (Cr), iron (Fe), nickel (Ni), and aluminum (Al) are mixed so as to have almost the same atomic ratio (Near-equiatomic) within a range where the total sum of the respective components is 100%, which is a condition for the high entropy alloy not to form an inter-alloy compound. According to an exemplary embodiment of the present invention, the mixing was done at the rate of Al16.7 Co16.7Cr16.7 Fe16.7 Ni16.7 Si16.7.

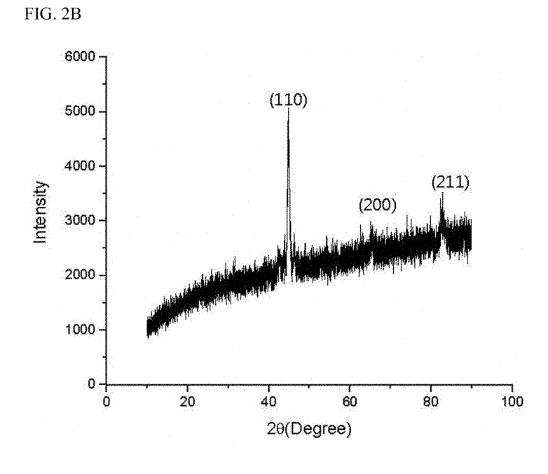

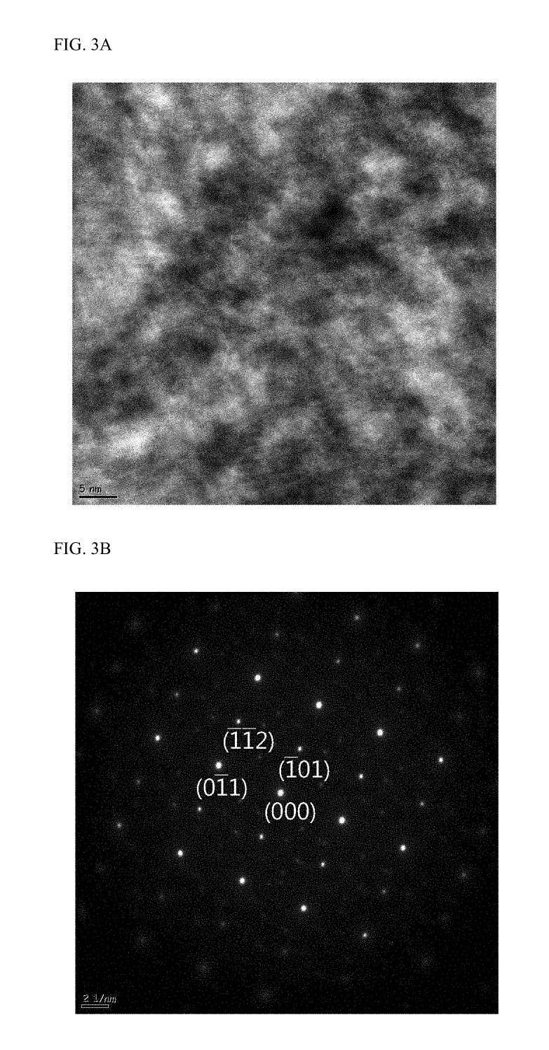

The vacuum arc melting method was used. And the alloying was done for 30 minutes under the condition of the degree of a vacuum 1.4×10e-3 torr, the arc power 3.5, voltage 16V, current 280 A. It was melted repeatedly 10 times to enhance the chemical homogeneity. In FIG. 2B, FIG. 3A, and FIG. 3B, it is confirmed that a High Entropy Alloy is formed as a solid solution having a crystal structure of a body-centered cubic lattice.

According to FIG. 2B, by checking the intensity peak of the 110, 200, and 211 planes of the mixed entanglement alloy formed according to the embodiment of the present invention through the X-ray diffraction experiment data, it is confirmed that it has a body-centered cubic (BCC) crystal structure. Also, it was confirmed that a single-phase High Entropy Alloy, not an intermetallic compound, was formed by confirming an intensity peak smaller than that of a conventional body-centered cubic (BCC) crystal structure.

Further, in FIG. 3A and FIG. 3B, it was confirmed that a solid solution having a body-centered cubic lattice structure, which is not an intermetallic compound, was formed through a high-resolution TEM image and a selected area electron diffraction (SAED) pattern of the High Entropy Alloy according to an exemplary embodiment of the present invention.

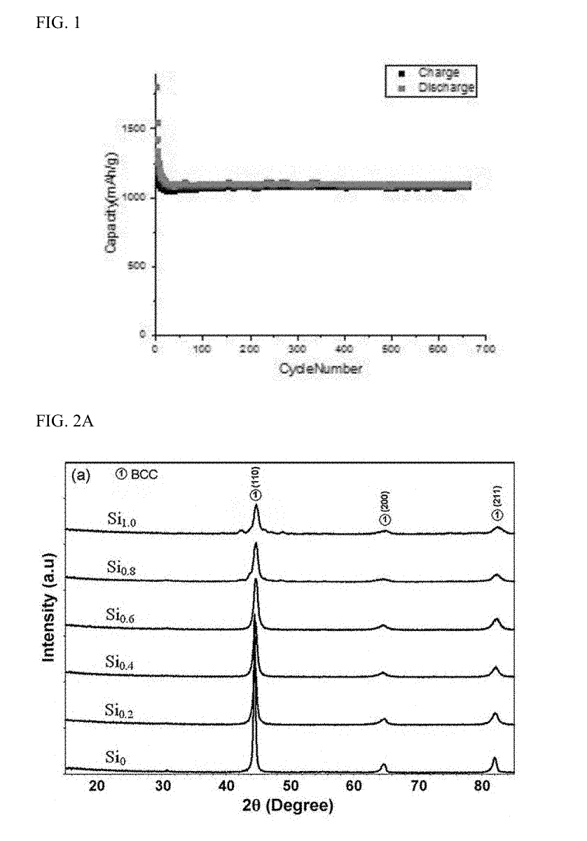

In FIG. 1, it is possible to confirm the change in capacity due to charging and discharging when a High Entropy Alloy composed of aluminum (Al), cobalt (Co), chromium (Cr), iron (Fe), nickel (Ni) according to an exemplary embodiment of the present invention is used as the anode active material. The first discharging capacity is 1700 mAh/g, and the charging capacity is about 1500 mAh/g. Therefore, it can be seen that the charging capacity per unit mass is much higher than that in the case of using a carbon-based anode active material and that the capacity retention ratio from 5 cycle to 600 cycle is about 87.45%. That is, although the initial irreversible phase is very large, as the capacity retention rate after 5 cycles after the stabilization phase is very excellent, the effect if having a very good charge and discharge capacity can be confirmed at 1000 mAh/g stably after 600 cycles. This is about 3 times better than the conventional graphite cathode capacity of 372 mAh/g.

Therefore, the negative electrode material for a secondary battery according to an exemplary embodiment of the present invention may have a capacity retention rate of 80 to 100%, particularly 85 to 90%, from 5 cycles to 600 cycles in charging and discharging processes.

Further, the first discharge capacity may be 1700-4200 mAh/g, and may have charge and discharge capacity of 1000-4200 mAh/g after 600 cycles.

In FIG. 1, in the case of a material of negative electrode for a lithium secondary battery according to an exemplary embodiment of the present invention, a High Entropy Alloy including silicon (Si) is used as an active material to serve as a buffer for buffering the volume expansion of silicon (Si) generated during the charging and discharging processes, and it was confirmed that it has an excellent capacity retention ratio and has an effect of improving life expectancy of the battery.

At this time, as the element constituting the High Entropy Alloy (hereinafter referred to as HEA) other than silicon (Si), other metal elements may be used within a range of mixing with silicon (Si) yet not forming an intermetallic compound. When selecting other metal elements, the following conditions are required to form a High Entropy Alloy.

ΔSmix>13.38 J/K·mol,

[symbol]

−10 kJ/K·mol<ΔHmix<5 kJ/K·mol

[symbol]

Atomic size difference<4%,

[symbol]

Therefore, by using the Miedema model, it is possible to select the elements satisfying the above conditions, and within the range satisfying the above conditions, the composition ratio of each element can be adjusted so that the total sum becomes 100%. Specifically, metal elements such as copper (Cu), zirconium (Zr), titanium (Ti), vanadium (V), manganese (Mn), tungsten (W), niobium (Nb) and molybdenum (Mo) can be used. Metal elements of copper(Cu), zirconium (Zr), titanium (Ti), vanadium (V), and manganese (Mn) can be used, and metal elements of tungsten (W), niobium (Nb), and molybdenum (Mo) can also be used.

Further, by forming the High Entropy Alloy through a fusion with the metal element other than the metal element used in the exemplary embodiment of the present invention, it can have a different crystal structure such as a face-centered cubic grating (FCC) in addition to the body-centered cubic grating (BCC).

The material of negative electrode for a lithium secondary battery according to an exemplary embodiment of the present invention is manufactured by mixing an alloyed active material such that the metal element including silicon (Si) has a ratio of Al_{16.7}Co_{16.7}Cr_{16.7}Fe_{16.7}Ni_{16.7}Si_{16.7} with a carbon-based conductive material and a binder. And this is applied to a current collector to produce a negative electrode for a secondary battery.

At this time, the alloyed active material is alloyed for about 30 minutes using an Arc Melter using silicon (Si), Cobalt (Co), Chromium (Cr), Iron (Fe), Nickel (Ni). The thus prepared alloy is pulverized into a powder having a size of about 26 um or less by using a Ball Mill, and the alloy powder is mixed with a conductive material and a binder in a ratio of 8:1:1 to manufacture an electrode by the method of Tape Casting.

In this case, the conductive material may be carbon black, carbon nanotubes, carbon powder, and graphite powder as the carbon-based conductive material, but other conductive materials may be also used, and the binder may be polyvinylidene fluoride (PVDF), but other materials may be also used as long as they do not impair the binding force and cycle characteristics of the electrode.

As a method for alloying a high entropy alloy active material for a material of negative electrode for a lithium secondary battery according to an embodiment of the present invention, an arc melting and casting method using an arc melter may be used, and powder metallurgy may be used without being limited thereto. Also, other alloying methods such as DC sputtering can be used.

While this invention has been described in terms of its characterization, structure, and effects in connection with what is presently considered to be practical exemplary embodiments, it is to be understood that the invention is not limited to the disclosed embodiments. Furthermore, the described characterization, structure, and effects of the embodiments may be modified in various different ways by those skilled in the art.

Therefore, the various modifications and equivalent arrangements are intended to be included within the spirit and scope of the present disclosure. While this invention has been described in connection with what is presently considered to be practical exemplary embodiments, it is to be understood that the invention is not limited to the disclosed embodiments, but, on the contrary, is intended to cover various modifications and equivalent arrangement included within the spirit and scope of the appended claims. For instance, each individual element described in the practical exemplary embodiments may be modified. And these differences related to modifications and applications are intended to be included within the scope of the present disclosure as defined in what is claimed.

What is claimed is:

1. A material of negative electrode for a lithium secondary battery comprising an anode active material containing silicon and an alloy of at least five kinds of metal elements that do not form an intermetallic compound with silicon.

2. A material of negative electrode for a lithium secondary battery of claim 1, wherein the metal elements which do not form the intermetallic compound with silicon are cobalt, chromium, iron, nickel, and aluminum.

3. A material of negative electrode for a lithium secondary battery of claim 1, wherein the alloy is composed of five kinds of metal elements which do not form an intermetallic compound with silicon and silicon, and each constituent element can be formed in a composition ratio of 1:1:1:1:1:1.

4. A material of negative electrode for a lithium secondary battery of any one of claim 1, wherein the alloy is a High Entropy Alloy structure that forms a solid solution.

5. A material of negative electrode for a lithium secondary battery of claim 4, wherein the alloy further includes at least one metal selected from the group consisting of copper, zirconium, titanium, vanadium, and manganese.

6. A material of negative electrode for a lithium secondary battery of claim 4, wherein the alloy further includes at least one metal selected from the group consisting of tungsten, niobium, and molybdenum.

7. A material of negative electrode for a lithium secondary battery of claim 1, wherein the alloy has a solid solution having a certain crystal structure including a face-centered cubic lattice or a body-centered cubic lattice structure.

8. A material of negative electrode for a lithium secondary battery of claim 1, wherein the material of negative electrode for a lithium secondary battery has a first discharge capacity of 1700˜4200 mAh/g.

9. A material of negative electrode for a lithium secondary battery of claim 1, wherein the material of negative electrode for a lithium secondary battery has a capacity retention rate of 80% to 100% from 5 cycles to 600 cycles in charging and discharging processes.

10. A material of negative electrode for a lithium secondary battery of claim 9, wherein the material of negative electrode for a lithium secondary battery has a capacity retention rate of 85% to 90% from 5 cycles to 600 cycles in charging and discharging processes.

11. A material of negative electrode for a lithium secondary battery of claim 1, wherein the material of negative electrode for a lithium secondary battery maintains a capacity of 1000-4200 mAh/g after 600 cycles in the processes of charging and discharging.

12. A material of negative electrode for a lithium secondary battery of claim 1, wherein the material of negative electrode for a lithium secondary battery comprises a conductive material selected from the group consisting of carbon black, carbon nanotube, carbon powder, and graphite powder.

13. A material of negative electrode for a lithium secondary battery of claim 12, wherein the material of negative electrode for a lithium secondary battery further comprises a binder for mixing the negative active material and the conductive material to form a slurry.

14. A material of negative electrode for a lithium secondary battery of claim 12, wherein the binder comprises polyvinylidene fluoride.

15. A material of negative electrode for a lithium secondary battery of claim 13, wherein the slurry is mixed with the negative electrode active material, the conductive material, and the binder in a ratio of 8:1:1.
